(19) United States
(12) Patent Application Publication
(10) Pub. No.: US 2006/0022932 A1
(43) Pub. Date: Feb. 2, 2006

(54) Display panel, drive circuit, display device, and electronic equipment

(75) Inventors: Takahiro Sagawa, Chino-shi (JP); Fumio Koyama, Shiojiri-shi (JP); Naganori Ito, Chino-shi (JP); Yasuyuki Kobayashi, Matsumoto-shi (JP); Yasushi Maruyama, Shiojiri-shi (JP); Ryosuke Higashi, Matsumoto-shi (JP); Katsumi Okubo, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/188,765

(22) Filed: Jul. 26, 2005

(30) Foreign Application Priority Data
Aug. 2, 2004 (JP) 2004-225915

(51) Int. Cl. G09G 3/36

(52) U.S. Cl. 345/98

(57) ABSTRACT

A display panel drive circuit according to exemplary embodiments of the invention include a source driver that applies a drive voltage corresponding to a display level of gray to a source line of an active element to drive each pixel of a display panel in which the display level of gray of each pixel is determined depending on accumulated charge between electrodes of each pixel. Exemplary embodiments further include a control unit that controls the drive voltage to be applied to the source line by the source driver and a potential of a common electrode of the display panel at the same potential in a predetermined period.

### BACKGROUND

Exemplary embodiments of present invention relate to a display panel drive circuit to drive a display panel, and a display device and electronic equipment having the display panel drive circuit built-in. Exemplary embodiments further relate, to processing of residual charge in the display panel in which a display level of gray of each pixel is determined depending on accumulated charge between electrodes of each pixel.

The related art includes a liquid crystal panel as a display panel that requires a retention capacitor to retain the charge condition of a pixel, while there is a request to avoid continuous application of a direct-current voltage to the pixel to avoid burn-in of pixel or the like. At the time of normal liquid crystal display, application of a direct-current component to the liquid crystal pixel is avoided by performing alternating-current driving. However, at the times of start-up and stop of the liquid crystal drive circuit, alternating-current driving is not properly performed, and thereby, a direct-current component is applied to the liquid crystal pixel or the residual charge in the retention capacitor is applied to the liquid crystal pixel. The state is the same as a state in which a direct-current component is applied, and causes deterioration of the liquid crystal. Related are document Japanese Patent Application Publication 2003-173172 discloses a method of preventing application of a direct-current component to the pixel and accelerating discharge of the retention capacitor by setting a video signal in a certain period after activation of a power supply and immediately before shut-down to a direct-current signal in a pixel writing period.

However, there has been a problem that, since the potential of a common electrode (opposite electrode) at the time of normal driving is not necessarily the same as a potential of the video signal that has been made into a direct-current signal, the direct-current component is applied slightly to the pixel due to the potential difference or charge remains because the discharge of the retention capacitor is not sufficiently performed.

### SUMMARY

Exemplary embodiments of the invention provide a display panel drive circuit capable of reliably discharging residual charge in the display panel and avoiding deterioration of the display panel due to residual charge. Exemplary embodiments further provide a display device and electronic equipment having the circuit built-in.

A display panel drive circuit according to an exemplary aspect of the invention includes: a source driver that applies a drive voltage corresponding to a display level of gray to a source line of an active element of a display panel in which the display level of gray of each pixel is determined depending on accumulated charge between electrodes of each pixel; and a control unit that controls the drive voltage to be applied to the source line by the source driver and a potential of a common electrode of the display panel at the same potential in a predetermined period. According to an exemplary aspect of the invention, since the drive voltage to be applied to the source line by the source driver and the potential of the common electrode of the display panel are controlled at the same potential in a predetermined period, the accumulated charge between electrodes of each pixel is forcibly discharged, the accumulated charge becomes zero, and the situation in which the direct-current component is applied to the pixel can be avoided. Further, in the case where the display panel is a liquid crystal panel and a retention capacitor is formed, similarly, the discharge of the retention capacitors can be sufficiently performed, and the situation in which charge remains can be avoided. Accordingly, the deterioration of the display panel can be avoided and display quality can be enhanced.

Further, in the display panel drive circuit according to an exemplary aspect of the invention, the control unit controls the drive voltage to be applied to the source line and the potential of the common electrode of the display panel at the same potential after a command of power OFF or after power ON. According to an exemplary aspect of the invention, since the drive voltage to be applied to the source line and the potential of the common electrode of the display panel are controlled at the same potential after a command of power OFF or after power ON and the accumulated charge is discharged, the residual charge at the time of power OFF or power ON is reliably discharged.

Further, in the display panel drive circuit according to an exemplary aspect of the invention, the control unit controls the drive voltage to be applied to the source line and the potential of the common electrode of the display panel at the ground potential. According to an exemplary aspect of the invention, since the drive voltage to be applied to the source line and the potential of the common electrode of the display panel are controlled at the ground potential, the residual charge is reliably discharged.

Further, the display panel drive circuit according to an exemplary aspect of the invention further includes a first switching unit that outputs one of the drive voltage corresponding to the display level of gray and the ground potential to the source driver; and a second switching unit that outputs one of a predetermined common electrode potential and the ground potential to the common electrode of the display panel. The control unit controls the first switching unit and the second switching unit to output the ground potential, respectively, after a command of power OFF or after power ON. According to an exemplary aspect of the invention, by switching the first switching unit and the second switching unit, respectively, the drive voltage to be applied to the source line and the potential of the common electrode of the display panel are controlled at the ground potential.

Further, in the display panel drive circuit according to an exemplary aspect of the invention, the control unit controls the drive voltage to be applied to the source line and the potential of the common electrode of the display panel at the same potential at least during one vertical period. According to exemplary embodiments, since the drive voltage to be applied to the source line and the potential of the common electrode of the display panel are controlled at the same potential at least during one vertical period (one cycle of vertical blanking time), the accumulated charge between electrodes of all pixels for one screen is discharged.

Further, in the display panel drive circuit according to an exemplary aspect of the invention, the control unit controls the drive voltage to be applied to the source line and the potential of the common electrode of the display panel at the same potential at least during one vertical period, and controls all active elements to be turned ON. According to an exemplary aspect of the invention, since the drive voltage to be applied to the source line and the potential of the common electrode of the display panel are controlled at the same potential at least during one vertical period and all active elements are controlled to be turned ON, the accumulated charge between electrodes of all pixels for one screen is discharged via the active elements.

Further, in the display panel drive circuit according to an exemplary aspect of the invention, the control unit controls the drive voltage to be applied to the source line and the potential of the common electrode of the display panel at the same potential after a command of power OFF, and then, controls all active elements to be turned OFF. According to an exemplary aspect of the invention, since all active elements are controlled to be turned OFF before moving to the normal operation, the abnormal video signal accompanying the subsequent power shut down can be reduced or prevented from affecting pixels.

Further, a display device according to an exemplary aspect of the invention includes: a display panel in which a display level of gray of each pixel is determined depending on accumulated charge between electrodes of each pixel; and the above display panel drive circuit. According to an exemplary aspect of the invention, a display device capable of avoiding deterioration of display panel and enhancing display quality is obtained by being provided with the above display panel drive circuit.

Further, a display device according to an exemplary aspect of the invention includes: a liquid crystal panel including a thin-film transistor corresponding to each pixel; a source driver to supply a video signal to a source line of the thin-film transistor; a gate driver to supply a gate voltage to a gate line of the thin-film transistor; and a control unit to supply a predetermined voltage in place of the video signal to the source line of the thin-film transistor via the source driver and supplies the predetermined voltage to a common electrode of the liquid crystal panel, and controls a potential of the source line and a potential of the common electrode at the same at least during one vertical period after a command of power OFF or after power ON.

Further, electronic equipment according to exemplary embodiments of the invention incorporates the above display device.

### BRIEF DESCRIPTION OF THE DRAWINGS

Exemplary embodiments of the invention will be described with reference to the accompanying drawings, wherein like numbers reference like elements and wherein:

FIG. 1 is a schematic showing a display device according to Exemplary Embodiment 1 of the invention;

FIG. 2 is a schematic showing details of a display unit;

FIG. 3 is a timing chart of signals of the respective parts when the power is OFF;

FIG. 4 is a timing chart of signals of the respective parts when the power is ON; and

FIG. 5 is a schematic showing a PDA having the above display device built-in.

### DETAILED DESCRIPTION OF EMBODIMENTS

### Embodiment 1

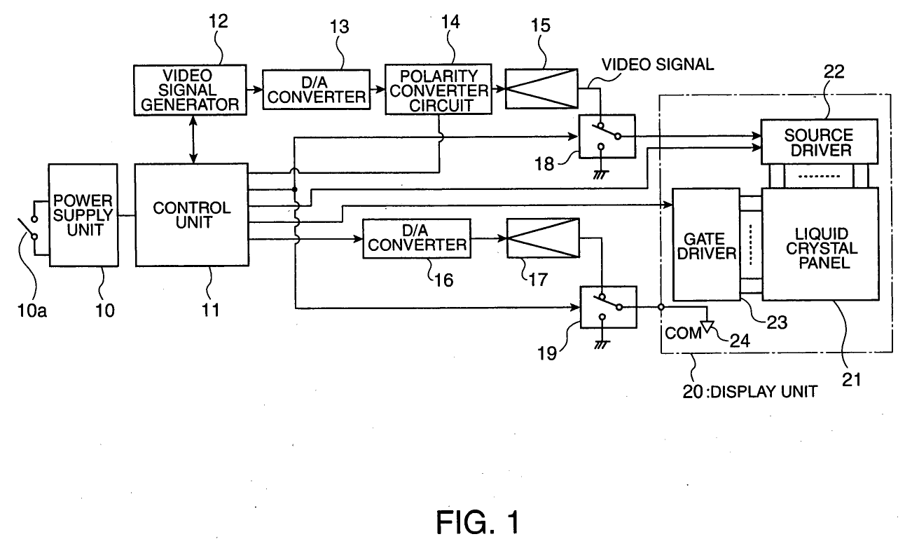

FIG. 1 is a schematic showing a display device according to the exemplary embodiment 1 of the invention. This display device is mounted to electronic equipment such as a PDA, and includes a power supply unit 10, a control unit 11, a video signal generator 12, a D/A converter 13, a polarity converter circuit 14, an amplifier 15, a D/A converter 16, an amplifier 17, switch circuits 18 and 19, and a display unit 20. The display unit 20 includes a liquid crystal panel 21, a source driver 22, and a gate driver 23. The liquid crystal panel 21 has a structure in which two transparent substrates such as glass substrates, for example, are bonded and a liquid crystal material is sandwiched in between, and a thin-film transistor (TFT) is provided to each pixel as an active device. Further, this liquid crystal panel 21 includes a reflection plate, for example, and displays a video utilizing incident light from outside.

The power supply unit 10 supplies drive power to the entire device when a switch 10a thereof is operated. The control unit 11 is for controlling the entire device and, for example, generates a polarity switch signal for the polarity converter circuit 14, switch signals for the switch circuits 18 and 19, start pulses X and Y (for the source driver and the gate driver), clock pulses XCL and YCL, a common electrode potential (COM potential), which will be described later, etc. Further, the video signal generator 12 generates a video signal based on a control signal of the control unit 11, the video signal is converted into an analog signal by the D/A converter 13 and polarity-converted, for example, with respect to each line by the polarity converter circuit 14, and then, amplified by the amplifier 15 and supplied to the switch circuit (first switching unit) 18. Further, the common electrode potential (COM potential) generated by the control unit 11 is converted into an analog signal by the D/A converter 16, and then, amplified by the amplifier 17 and supplied to the switch circuit (second switching unit) 19. The switch circuit 18 outputs one of the video signal from the amplifier 15 and the ground potential to the source driver 22 of the display unit 20 based on the switch signal from the control unit 11, and, at the time of normal driving, selects the video. signal and outputs it to the source driver 22 of the display unit 20. Further, the switch circuit 19 feeds one of the common electrode potential (COM potential) from the amplifier 17 and the ground potential to a common electrode (opposite electrode) COM 24 of the display unit 20 based on the switch signal from the control unit 11, and, at the time of normal driving, selects the common electrode potential (COM potential) and supplies it to the common electrode COM 24 of the display unit 20.

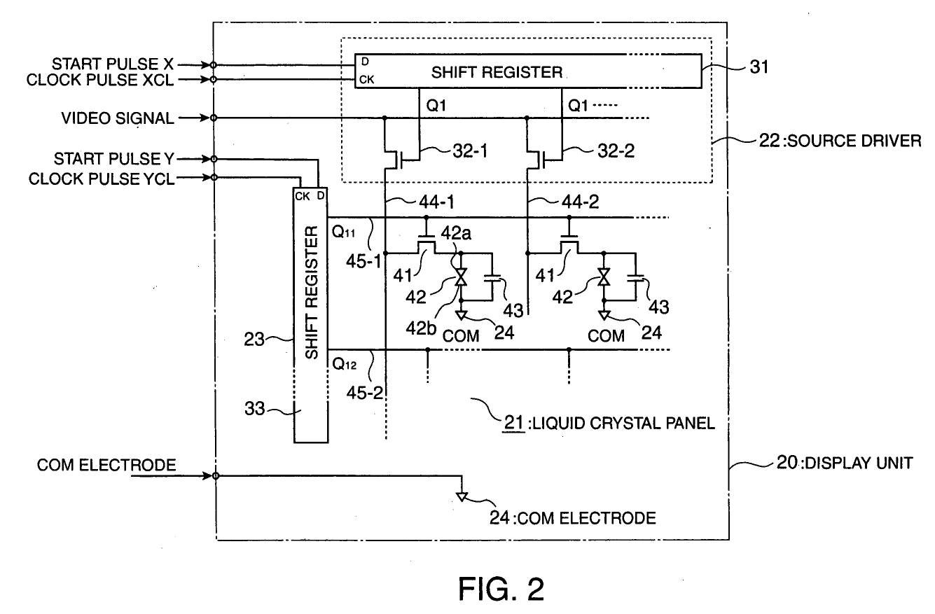

FIG. 2 is a circuit diagram showing details of the display unit 20. The source driver 22 is formed by a shift register 31 and switching transistors 32-1, 32-2, . . . to be driven by the shift register 31, and the gate driver 23 is formed by a shift register 33. In the liquid crystal panel 21, a thin-film transistor 41 and a liquid crystal 42 and a retention capacitor 43 to be driven by the thin-film transistor 41 are provided corresponding to each pixel. A display electrode 42a of the liquid crystal 42 is connected to the drain of the thin-film transistor 41 and an opposite electrode 42b is connected to the common electrode 24. Accordingly, the opposite electrode 42b and the common electrode 24 are constantly at the same potential, and, as the potential of the common electrode 24 changes, the potential of the opposite electrode 42b inevitably changes.

To the shift register 31 of the source driver 22, a start pulse X (horizontal synchronizing signal) and a clock pulse XCL are supplied and the video signal is supplied to the source of the switching transistor 32. When the start pulse X and the clock pulse XCL are supplied to the shift register 31, the start pulse X is sequentially sent out from output terminals Q1, Q2, . . . of the shift register 31 according to the timing of the clock pulse XCL, the switching transistors 32-1, 32-2, . . . are sequentially turned on, and the video signal is sequentially applied to source lines 44-1, 44-2, . . . . Further, a start pulse Y (vertical synchronizing signal) and a clock pulse YCL are supplied to the shift register 33, and the start pulse Y is sequentially sent out from output terminals Q11 and Q12 thereof according to the timing of the clock pulse YCL and sequentially applied to gate lines 45-1, 45-2, . . . . The thin-film transistors 41 of the liquid crystal panel 21 are driven by being sequentially applied with video signals to the source lines 44-1, 44-2, . . . by the driving of the source driver 22 and gate voltages to the gate lines 45-1, 45-2, . . . by the gate driver 23. Thus, the thin-film transistors 41 are sequentially driven in the horizontal direction and vertical direction, video signals are supplied to the liquid crystals 42 and retention capacitors 43, and pixel display in response to the charge accumulated in the liquid crystals 42 and retention capacitors 43 are performed. Thereby, an image in response to the video signals can be obtained in the liquid crystal panel 21.

The operation of normal driving condition according to exemplary embodiment has been described above, and next, the operation peculiar to the exemplary embodiment will be described.

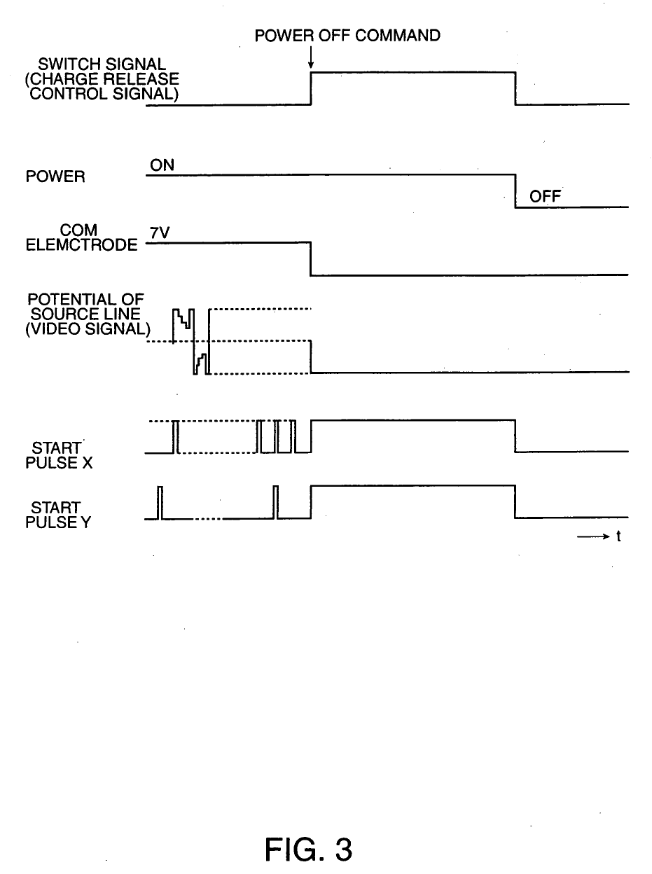

FIG. 3 is a timing chart of signals of the respective parts when the power is OFF. In the condition in which an image is displayed on the liquid crystal panel 21 of the display device in FIG. 1, the power is turned OFF when the switch 10a of the power supply unit 10 is operated. Here, the operation immediately before the OFF-state will be described. When the switch 10a of the power supply unit 10 is OFF-operated, the control unit 11 detects the OFF-operation, generates switch signals (charge release control signals), and outputs them to the switch circuits 18 and 19. Further, with the generation of the switch signals (charge release control signals), the start pulse X and start pulse Y are shaped into pulses with predetermined duration corresponding to at least two frames (two vertical periods) and output. The switch circuit 18 switches the video signal based on the switch signal from the control unit 11 and outputs the ground potential (0V) to the source driver 22. Further, the switch circuit 19 switches the common electrode potential (COM potential) that has been output from the control unit 11 and outputs the ground potential (0V) to the common electrode 24 of the display unit 20. Thereby, the potential of the common electrode 24 becomes the ground potential (0V).

Since the start pulse X and start pulse Y have become pulses with predetermined duration corresponding to at least two frames (two vertical periods) as described above, the respective outputs are continuously output from the output terminals Q1, Q2, . . . of the shift register 31 and the output terminals Q11, Q12, . . . of the shift register 33. All of the thin-film transistors 41 of the liquid crystal panel 21 are finally turned ON before the time for one frame elapses. Furthermore, the state is maintained in the next time for one frame. At this time, since the potential of the source line 44 provided via the switching transistor 32 and the potential of the common electrode 24 (i.e., the potential of the opposite electrode 42b) become the ground potential (0V) and the same potential, the charge accumulated in the liquid crystals 42 and the retention capacitors 43 is reliably discharged via the thin-film transistors 41. Accordingly, of the liquid crystals 42 and the retention capacitors 43, the time corresponding to two frames is a discharge period in the longest one, and the time corresponding to one frame is a discharge period in the shortest one. In this condition, when the liquid crystal panel 21 is in the normally white mode, the entire screen becomes white, and, when the liquid crystal panel 21 is in the normally black mode, the entire screen becomes black. Then, the power supply unit 10 is turned OFF and the entire processing is ended.

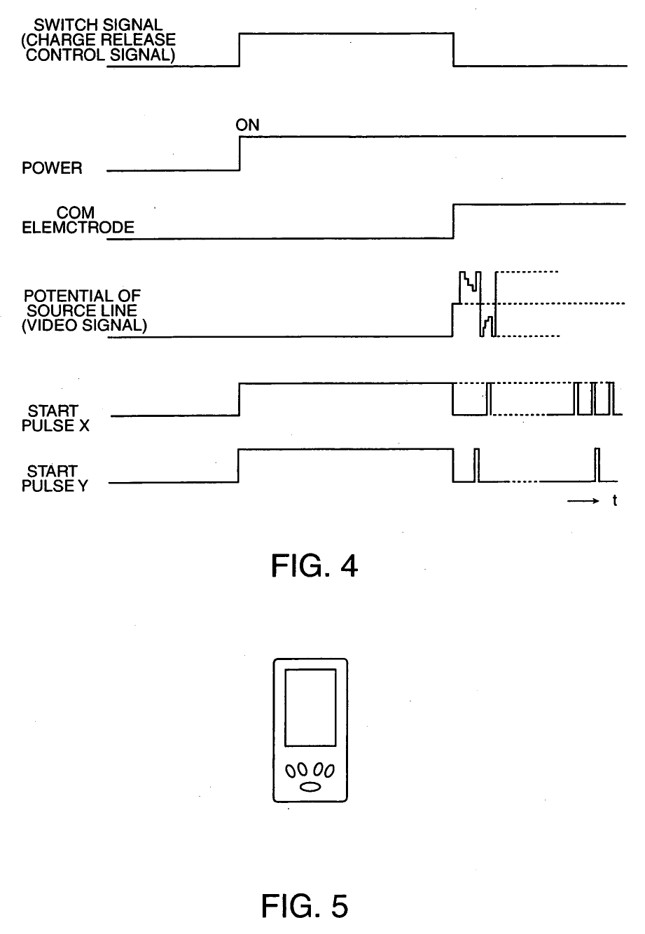

FIG. 4 is a timing chart of signals of the respective parts when the power is ON. The operation when the switch 10a of the power supply unit 10 is operated and turned ON will be described. When the switch 10a of the power supply unit 10 is operated and turned ON, the control unit 11 detects the operation, shapes switch signals (charge release control signals), and outputs them to the switch circuits 18 and 19. Further, with the generation of the switch signals (charge release control signals), the start pulse X and start pulse Y are generated into pulses with predetermined duration corresponding to at least two frames and output. The switch circuit 18 selects the ground potential (0V) based on the switch signal and outputs it to the source driver 22. Further, the switch circuit 19 selects the ground potential (0V) and outputs it to the common electrode 24 of the display unit 20. Thereby, the potential of the common electrode 24 becomes the ground potential (0V). Then, the source driver 22 and the gate driver 23 operate in the same way as in the above example, and all of the thin-film transistors 41 of the liquid crystal panel 21 are finally turned ON after the time for one frame elapses. Furthermore, the state is maintained in the next time for one frame. At this time, since the potentials of the source lines 44-1, 44-2, . . . and the potential of the common electrode 24 become the ground potential (0V) and the same potential, the charge accumulated in the liquid crystals 42 and the retention capacitors 43 flows via the thin-film transistors 41 is discharged. Then, after the operation, the control unit 11 turns the switch signals OFF, and thereby, the switch circuit 18 outputs the video signal to the source driver 22 and the switch circuit 19 supplies the common electrode potential (COM potential) to the common electrode 24 to return the start pulse X and start pulse Y into the normal pulse forms, and thereby, an image corresponding to the video signal is displayed on the liquid crystal panel 21.

As described above, in the exemplary embodiment, since the source lines 44-1, 44-2, . . . and the common electrode 24 of the liquid crystal panel are set at the ground potential (0V), at the time of OFF command or ON of the power supply unit 10, the charge accumulated in the liquid crystals 42 and the retention capacitors 43 can be discharged and made into zero. Further, since the discharge period is set to at least time corresponding to one frame, the discharge is reliably performed.

### Exemplary Embodiment 2

In the example in FIG. 3, the example in which the power is shut down after the writing processing of setting the source lines 44-1, 44-2, . . . and the common electrode 24 at the ground potential (0V) has been described. However, by turning OFF all of the thin-film transistors 41 before the power is shut down, the abnormal video signal accompanying the subsequent power shut down can be reduced or prevented from affecting pixels. Specifically, by setting the start pulse X and start pulse Y at L-levels at least in the time corresponding to one frame, the thin-film transistors 41 are gradually turned OFF, and finally, the thin-film transistors 41 of the all pixels can be turned OFF.

### Exemplary Embodiment 3

Further, in the above exemplary embodiment, the example in which the source lines 44-1, 44-2, . . . and the common electrode 24 are set at the ground potential (0V) has been described, however, exemplary embodiments of the invention are not limited to the example. For example, both potentials may be set at the same by setting the source line at the common electrode potential, or both potentials may be set at the same by making the potential of the source line and the common electrode potential into direct-current components of the video signal. Further, the example in which all of the thin-film transistors are turned ON in the time for one frame has been described in the exemplary embodiment, however, the time can be set longer in exemplary embodiment of the invention.

Further, the reflective type example including the reflection plate for video display utilizing the incident light from outside has been described as the liquid crystal panel 21. However, exemplary embodiments of the invention can be applied to a transmissive type for video display utilizing backlight or semi-transmissive reflective type provided with a semi-transmission plate at the inner side of the display panel for video display utilizing both characteristics of the reflective type and transmissive type by the backlight. Furthermore, the example of the liquid crystal panel 21 using thin-film transistors has been described as an example of the display panel in which a display level of gray of each pixel is determined depending on accumulated charge between electrodes of each pixel. However, not limited to the liquid crystal, the same effect can be obtained with respect to other display panels in which pixels are driven by active elements and a video signal is determined depending on the charge accumulated between electrodes of the pixels.

### Exemplary Embodiment 4

FIG. 5 is a schematic showing a PDA having the display device according to the above embodiments built-in. Exemplary embodiments of the invention can similarly be applied to various kinds of electronic equipment such as a personal computer, cellular phone, liquid crystal projector other than the PDA.

What is claimed is:

1. A display panel drive circuit, comprising:
a display panel;
an active element including a source line;
a source driver that applies a drive voltage corresponding to a display level of gray to the source line of the active element to drive each pixel of the display panel, the display level of gray of each pixel being determined depending on accumulated charge between electrodes of each pixel; and
a control unit that controls the drive voltage to be applied to the source line by the source driver and a potential of a common electrode of the display panel at a same potential in a predetermined period.

2. The display panel drive circuit according to claim 1, the control unit controlling the drive voltage to be applied to the source line and the potential of the common electrode of the display panel at the same potential after a command of power OFF or after power ON.

3. The display panel drive circuit according to claim 2, the control unit controlling the drive voltage to be applied to the source line and the potential of the common electrode of the display panel at a ground potential.

4. The display panel drive circuit according to claim 1, further comprising:
a first switching unit that outputs one of the drive voltage corresponding to the display level of gray and a ground potential to the source driver; and
a second switching unit that outputs one of a predetermined common electrode potential and the ground potential to the common electrode of the display panel,
the control unit controlling the first switching unit and the second switching unit to output the ground potential, respectively, after a command of power OFF or after power ON.

5. The display panel drive circuit according to claim 1, the control unit controlling the drive voltage to be applied to the source line and the potential of the common electrode of the display panel at the same potential at least during one vertical period.

6. The display panel drive circuit according to claim 1, the control unit controlling the drive voltage to be applied to the source line and the potential of the common electrode of the display panel at the same potential at least during one vertical period, and controlling all active elements to be turned ON.

7. The display panel drive circuit according to claim 2, the control unit controlling the drive voltage to be applied to the source line and the potential of the common electrode of the display panel at the same potential after a command of power OFF, and then, controlling all active elements to be turned OFF.

8. A display device, comprising:
a display panel in which a display level of gray of each pixel is determined depending on accumulated charge between electrodes of each pixel; and
the display panel drive circuit according to claim 1.

9. A display device, comprising:
a liquid crystal panel including a thin-film transistor corresponding to each pixel;
a source driver to supply a video signal to a source line of the thin-film transistor;
a gate driver to supply a gate voltage to a gate line of the thin-film transistor; and
a control unit that supplies a predetermined voltage in place of the video signal to the source line of the thin-film transistor via the source driver and supplies the predetermined voltage to a common electrode of the liquid crystal panel, and controls a potential of the source line and a potential of the common electrode at the same potential at least during a vertical period after a command of power OFF or after power ON.

10. Electronic equipment, comprising:
the display device according to claim 8.
